(19) United States
(12) Patent Application Publication
(10) Pub. No.: US 2025/0381645 A1
(43) Pub. Date: Dec. 18, 2025

(54) EXTRACTOR FOR A GRINDER

(71) Applicant: BAE SYSTEMS plc, London (GB)

(72) Inventors: Danny Millar, London (GB); Patrick Burgess, London (GB); James Twelftree, London (GB)

(73) Assignee: BAE SYSTEMS plc, London (GB)

(21) Appl. No.: 18/785,308

(22) Filed: Jul. 26, 2024

(30) Foreign Application Priority Data
Jun. 14, 2024 (AU) 2024901811

(51) Int. Cl. B24B 55/10

(52) U.S. Cl. CPC B24B 55/102

(57) ABSTRACT

An extractor for a grinder. The extractor includes a partially enclosed body for positioning around a grinding disc of the grinder, the body having first and second walls welded to a covering portion that extends partially around a perimeter of each wall. The extractor further includes a port on the body with a passageway from the body to an outlet of the port, wherein vacuum applied to the extraction port draws grinding particulate created by operation of the grinder on a material from inside the body to the outlet for extraction. A barrel grinder that includes an extractor. A method of fabricating an extractor for a grinder.

### CROSS-REFERENCE TO RELATED APPLICATION

This application claims the benefit of and priority to Australian Provisional Patent Application No. 2024901811 filed on Jun. 14, 2024, which is hereby incorporated herein by reference in its entirety.

### TECHNICAL FIELD

The present disclosure relates to an extractor for a grinder, a barrel grinder with the extractor, and a method of fabricating an extractor for a grinder, in particular an extractor for extracting grinding particulate.

### BACKGROUND

In a wide variety of fabrication and metalworking activities, sections or portions of raw/un-fabricated metal materials are provided in a coating, typically primer paint, to protect the material from oxidation or other damage prior to use. Primer paints must be removed prior to commencing work (in particular welding) on the metal surface. Failure to fully remove primer paints prior to welding operations can cause impurities to become trapped within the welded material, leading to weld failure, unwanted fumes, etc.

One method for removing the primer paint is by grinding away the primer using an abrasive disc, wheel or blade, typically powered by a rotational grinder. For flat or planar surfaces, the grinder style used is a barrel grinder, also referred to as a straight grinder, being one which has the rotating drive of the grinder axially aligned to the handle of the grinder. However, the grinding process generates significant amounts of airborne particulate or dust, particulate which is hazardous and which has the potential to contaminate a large work area putting surrounding workers at risk of inhalation, as well as increasing the clean-up requirements of that work area.

For example, during shipbuilding programs, the primer paint removal activity may necessitate relocation of the activity and relevant materials outside of the main production area, to ensure that the airborne particulates do not contaminate a large work area and/or affect the health and safety of surrounding workers. This may cause a significant time and labour burden, and rely solely on physical isolation to subdue the issues caused by the particulate/dust created during grinding.

Extractors can be used for removing particulates created during grinding before they are able to contaminate the work area and/or become widely airborne. Typically such extractors comprise a length of vacuum ducting positioned close to the grinder, however, such ducting does not adequately prevent at least part of the particulate becoming airborne or spreading. Previous attempts to reduce the spread of particulate once created have included complex grinding tools and mounting apparatus for positioning vacuum ducting atop or on the grinding tool. While such tools and apparatus can increase the percentage of particulate captured for extraction, they are typically both expensive to produce and difficult to operate.

It is desired to address or at least ameliorate one or more disadvantages or limitations associated with the extraction of particulate created during material grinding operations.

### SUMMARY

In a first aspect of the present disclosure, there is provided an extractor for a grinder, comprising: a partially enclosed body for positioning around a grinding disc of the grinder, the body having first and second walls welded to a covering portion that extends partially around a perimeter of each wall; and a port on the body with a passageway from (inside) the body to an outlet of the port, wherein vacuum applied to the port draws grinding particulate created by operation of the grinder on a material from inside the body to the outlet for extraction.

Such an extractor has been found to be particularly advantageous by the Applicant through a series of tests and developments. In particular, it has been found that implementation of an extractor for a grinder in accordance with the present disclosure has the potential to remove more than about 90% of airborne particulates/contaminants generated during the grinding of primer paints from metal surfaces. The particulates pose a significant hazard and have the potential to contaminate a large work area, putting surrounding workers at risk of particulate inhalation as well as increasing the clean-up requirements of the work area. Accordingly, the extractor disclosed herein is particularly useful in addressing the disadvantages and limitations associated with conventional grinding operations to remove primer coatings. The extractor disclosed additionally allows for grinding activities to be undertaken ‘in situ’ (i.e., without the relocation of components being ground), and therefore the use of such an extractor can positively affect the productivity of workers during fabrication activities.

In some embodiments, one of the walls is partially removable to provide access for removing the grinding disc without removal of the extractor. The partially removable wall may be hingedly attached to the covering portion.

The extractor may further comprise a retainer for retaining the partially removable wall to the covering portion. The retainer may comprise a fastener fastenable through the partially removable wall and to the covering portion for retaining the partially removable door to the covering portion. The retainer may comprise a latch disposed on the wall or on the covering portion and connectable to the other for retaining the wall to the covering portion.

The second wall may comprise a coupler for coupling the extractor to the grinder and positioning the body around the grinding disc of the grinder. The coupler may comprise coupling portions fastenable together to couple the grinder therebetween.

The passageway of the port may be from the covering portion of the body to the outlet of the port. The port may be positioned to draw grinding particulate from an outer circumference of the grinding disc when vacuum is applied to the port. The extraction port may comprise a fitting disposed proximate the outlet of the port, the fitting for fitment of a vacuum source thereto. The fitting may be in the form of a bayonet fitting.

The walls may comprise edges corresponding to a portion of each wall which the covering portion does not extend partially around, and past which the grinding disc of the grinder is exposed when a grinder is attached to the extractor. The edges may be substantially planar.

The first wall may comprise a protrusion for housing a grinding disc fastener of the grinder when the extractor is attached to the grinder.

In some embodiments, the walls are substantially circular and comprise a diameter of about 166 mm. The walls and the covering portion may be fabricated from steel. The steel may be stainless steel. The extractor may be for attachment to a barrel grinder.

In a second aspect of the present disclosure, there is a provided a barrel grinder having an extractor in accordance with the first aspect; and a grinding disc, optionally an abrasive disc, optionally an abrasive impregnated nylon grinding discs.

In a third aspect of the present disclosure, there is provided a method of fabricating an extractor for a grinder, comprising: welding a covering portion around a perimeter of a pair of spaced apart walls to form a partially enclosed body; fitting, to the body, a port to provide a passageway from in the body to an outlet of the port; and arranging a coupler, for coupling the extractor to a grinder and positioning the body around the grinder, on one of the walls.

Fabricating an extractor in accordance with this method provides for uniquely simple manufacturing. The fabricated extractor can be fabricated without the use of expensive tools and can be fabricated using only common and typical metal workshop tools. Furthermore, the positioning of the port results in an extractor that targets the extraction of particulate at or around the outer circumferential edge of the grinding disc, and is therefore well-suited to use with barrel grinders.

In some embodiments, the walls are substantially parallel to one another, and the covering portion is substantially perpendicular to the walls.

### BRIEF DESCRIPTION OF THE DRAWINGS

Some embodiments of the present invention will now be described, by way of non-limiting example only, with reference to the accompanying drawings, in which:

FIG. 1 is a front perspective view of an extractor, according to an example;

FIG. 2 is a partial rear perspective view of an extractor, according to another example;

FIG. 3 is a front perspective view of the example extractor shown in FIG. 1, with a portion of one of the walls of the extractor opened and thus removed;

FIG. 4 is a rear perspective view of the example extractor shown in FIG. 1;

FIG. 5 is partial perspective view of the example extractor shown in FIG. 1, attached to a barrel grinder;

FIG. 6 is a perspective view of a prior art barrel grinder in use;

FIG. 7 is a perspective view of the extractor attached to a barrel grinder shown in FIG. 5 in use; and

FIG. 8 is a flow chart of a method of fabricating an extractor for a grinder as disclosed herein.

### DETAILED DESCRIPTION

Disclosed herein is an extractor 100 for a grinder 200, comprising a partially enclosed body 10 for positioning around a grinding disc 210 of the grinder 200, the body 10 having first and second walls 12, 14, welded to a covering portion 16 that extends partially around a perimeter of each wall 12, 14; and a port 28 on the body 10 with a passageway from (in) the body 10 to an outlet 30 of the port 28, wherein vacuum applied to the port 28 draws grinding particulate created by operation of the grinder 200 on a material from inside the body 10 to the outlet 30 for extraction. Advantageously, such an extractor 100 is particularly useful for extracting potentially dangerous and harmful particulate created during grinding operations, such as, for example, the removal of primer paint from metal surfaces in a marine/shipbuilding setting.

The extractor 100 disclosed herein is particularly suitable for attachment to a barrel grinder. Accordingly, the extractor 100 may be provided as part of, or already attached to, a barrel grinder. In this way, also disclosed herein is also a barrel grinder 200 having an extractor 100. Such a barrel grinder 200 is one which has an extractor 100, and preferably also includes a grinding disc 210. The grinding disc 210 may be an abrasive grinding disc 210, and preferably is an abrasive impregnated nylon grinding disc 210. The extractor 100 is suitable for extracting particulate created/generated during a variety of grinding operations and with a variety of grinding discs and wheels, including, for example, sanding discs, diamond grinding wheels and zirconium oxide flap discs. In particular the extractor 100 is suitable for use with a grinding disc 210, which may be an abrasive disc configured to remove coatings, such as primer paint, from a surface without damaging that surface. The grinding disc 210 may be referred to as a grinding ‘wheel’, a ‘stripping’ disc, or a ‘rip and strip’ disc. For example, the extractor 100 may be configured specially for abrasive discs in the form of abrasive (such as silicon carbide abrasive mineral) impregnated nylon grinding discs 210.

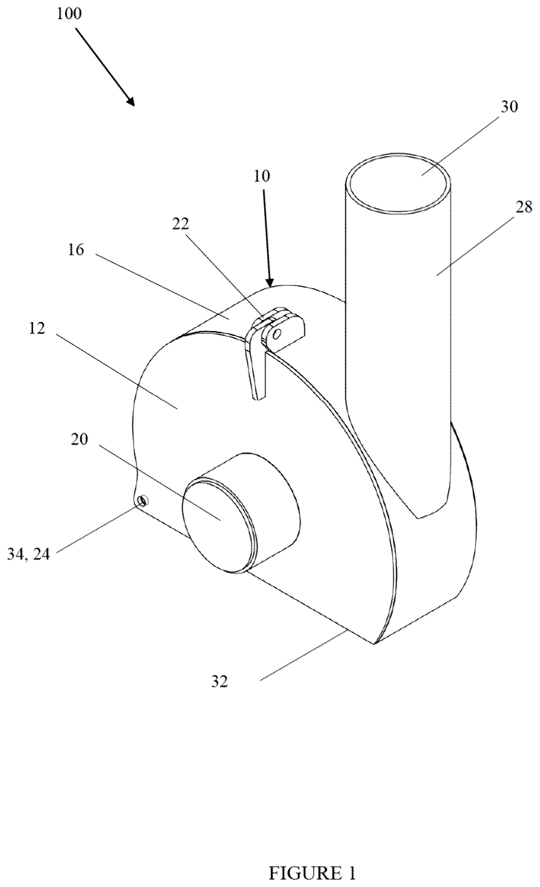

FIG. 1 shows an embodiment of the extractor 100. As shown in FIG. 1, the extractor 100 comprises a main partially enclosed body 10, which, in use, is positioned around a grinding disc 210 of the grinder 200 to encircle or surround at least a non-grinding portion of the disc. Accordingly, the body 10 is substantially hollow such that, when attached to the grinder 200, the body 10 substantially, but not entirely, covers the disc 210 thereof, leaving only a grinding portion of the disc 210 exposed. The grinding portion is generally a circular segment of the disc 210 that is free of the body 10 and aligned for contacting the surface to be ground, in use.

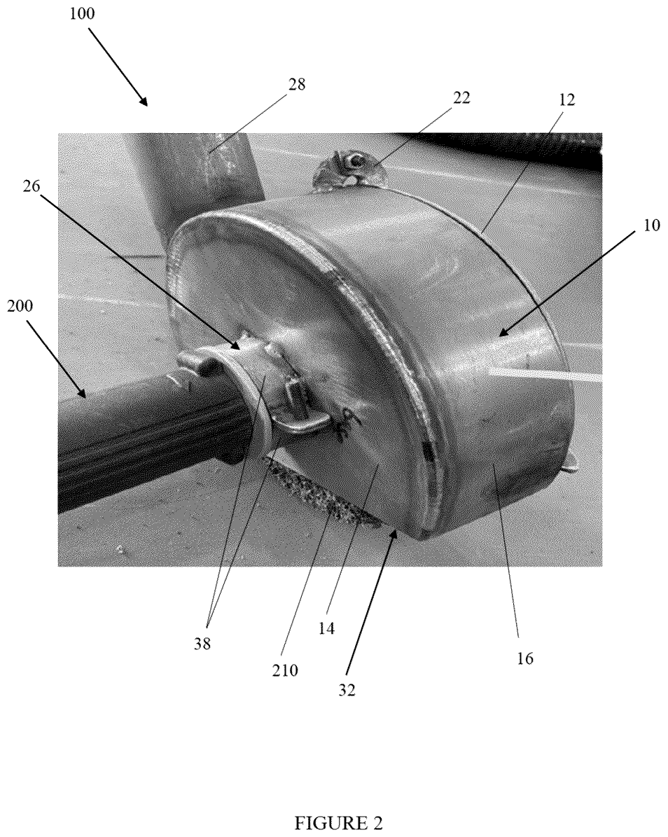

In FIG. 1, it can be seen that the body 10 comprises first and second walls 12, 14, the walls 12, 14 being spaced by, and connected by welding, to a covering portion 16. The covering portion 16 extends from each wall 12, 14 in a substantially perpendicular direction thereto, in this way extending partially around a perimeter of each wall 12, 14 to enclose the disc 210 in use as described hereinbefore. The walls 12, 14 are substantially circularly shaped to correspond to the substantially circular shape of typical grinder discs 210. In the embodiment of FIGS. 1 and 2, the extractor 100 is configured to suit attachment to a substantially 6″ (˜150 mm) (or smaller) diameter disc, and so the walls 12, 14 are each substantially 166 mm in diameter. Similarly, the covering portion 16 is substantially 52 mm in width to suit attachment of a substantially 2″ (51 mm) (or smaller) width disc.

FIG. 2 shows an embodiment of the extractor 100 with the walls 12, 14 and the covering portion 16 fabricated from steel. In particular, the walls 12, 14 and covering portion 16 are fabricated from stainless steel in the embodiment of FIG. 2. The port 28 may also be fabricated from steel, including stainless steel, in the embodiment of FIG. 2. Accordingly, exemplary embodiments of the extractor 100 are fabricated in a metal working shop, using metal working tools such as a welder and a metal cutting apparatus. Depending on the application environment, e.g., which may be a ship building yard, fabricating exemplary embodiments of the extractor 100 from a steel material may result in an extractor 100 that is more easily and readily fabricated, and/or repaired than, for example, an exemplary embodiment of the extractor 100 manufactured from a polymer material (e.g., injection moulded). Furthermore, fabricating the extractor 100 from stainless steel, in particular, provides embodiments of the extractor 100 that are durable and corrosion resistant, therefore not requiring the walls 12 or covering portion 16 to be coated (such as in paint or another coating) to prevent corrosion/rust. In preferred embodiments, the extractor 100 is fabricated using 2-mm thick stainless steel plate. Such a thickness of steel plate may be advantageous as it provides adequate strength to additionally resist failure/breakage when dropped, or if, for example, the grinding wheel 210 becomes damaged and breaks apart while being operated, while being relatively light in weight compared to thicker steel plate. Accordingly, embodiments of the extractor 100 can be used in place of a typical guard on the grinder 200. What is meant by this is that, due to its rigid construction and high strength when fabricated from steel, the extractor 100 additionally serves as a guard when attached to a grinder 200, preventing accidental contact with the grinding wheel 210 and protecting a user from fragments of the grinding wheel 210 if it explodes or otherwise breaks. Therefore, the extractor 100 disclosed herein is preferably suitable to both allow for the extraction of particulate and act as a tool guard.

As shown in FIG. 1, the walls 12, 14 may include exposed edges 32. The exposed edges 32 of the walls 12, 14 define the non-grinding portion, in other words, a portion of each wall 12, 14 that the covering portion 16 does not extend around. The exposed edges 32 are non-circular such that, when installed, the grinding wheel 210 of the grinder 200 extends past the exposed edges 32 to be exposed from (i.e., extending past and out of) the body 10 of the extractor 100. In exemplary embodiments, the exposed edges 32 are substantially coplanar, and thus can be referred to as a flattened portion of the side walls 12, 14. The exposed edges 32 are held at or about a bottom of the extractor 100 in use. The exposed edges 32 allow the grinding portion of the grinding disc 210 to protrude from the attached extractor 100, thus allowing for grinding operations (as described with reference to the edges 32). Additionally, the flattened portion provided by the exposed edges 32 allows the extractor 100 to not interfere with the grinder 200 when being used against an upright flat surface, such as, for example, when grinding against or toward the corner of a wall material or other pair of perpendicular materials.

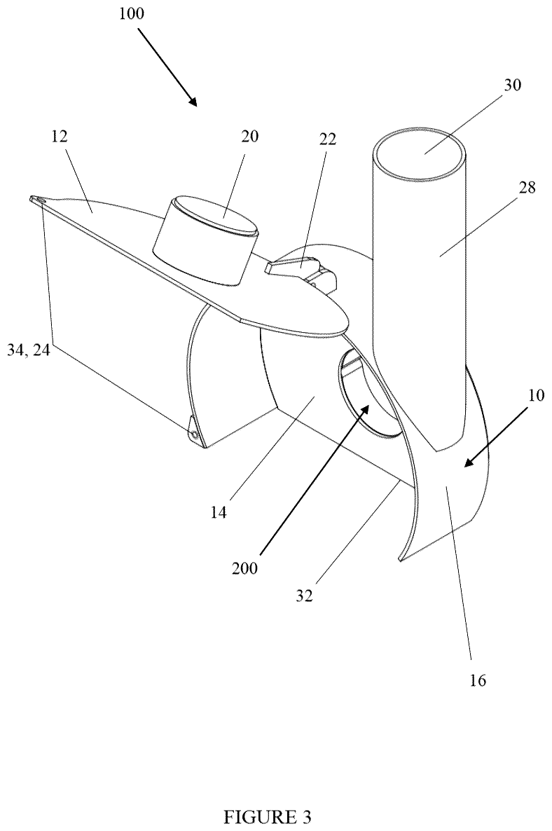

As shown in FIG. 1, the first wall 12 includes a protrusion 20 for housing a grinding disc fastener 220 of the grinder 200 when the extractor 100 is attached to the grinder 200. The protrusion 20 is preferably concentric with the first wall 12. The protrusion 20 is circular and hollow. What is meant by this is that the protrusion 20 provides an increased volume within the body 10 (as may be best seen in FIG. 3). The protrusion 20 is provided in the wall 12 as relief for the grinder disc fastener 220 (being the fastener with which the wheel or disc of the grinder is attached thereto). The inclusion of the protrusion 20 allows for the grinder fastener 220 to partially protrude beyond the face of the disc 210 in a perpendicular direction (as is common in various disc designs) without impacting/contacting the extractor 100 and thus affecting its operation.

As shown in FIG. 3, a portion of one of the walls 12 is partially removable by being openable to provide access (to the grinder 200) for removing the grinding disc 210 without removal of the extractor 100 from the grinder 200. The wall which is partially removable is the wall which corresponds to the side of the grinder 200 at which the grinding disc fastener 220 is positioned. Accordingly, in the Figures, the first wall 12 is the partially removable wall. In alternate embodiments, both walls 12, 14 may be partially removable to allow for attachment of the extractor 100 to grinders 200 having the grinding disc fastener 220 on either side. The partially removable wall 12 is hingedly attached to the covering portion 16. What is meant by this is that the partially removable wall 12 includes a hinge 22 for hingedly opening the wall 12 from the body 10. What is meant by this is that the front side wall 22 may be provided in the form of a door or window, and that, by inclusion of the hinge 22, that door or window is openable to permit access into the hollow interior of the body 10 (and, in use, the grinder therein) without complete or entire removal of that wall 12. Advantageously, this allows for rapid attachment of the extractor 100 to a grinder 200, and allows access to the grinder 200 in between use to check for things such as wear on the disc 210, clogging from particulate, or other issues.

To prevent the partially removable wall/s from flapping or inadvertently opening during use, the wall 12 and adjacent covering portion 16 include a retainer 34 for (releasably) retaining the partially removable wall 12 to the covering portion 16. In the embodiments shown, the retainer 34 comprises a fastener 24. When the wall 12 is in a closed position, the fastener 24 can be fastened through the wall 12 and to the covering portion 16 to retain the wall 12 and portion 16 proximate one another (i.e., in the closed position). In this embodiment, a through-hole is provided in the partially removable wall 12, and a threaded hole is provided in the covering portion 16. Accordingly, the fastener 24 can be in the form of a threaded bolt or other fastener, and can be inserted through the through-hole in the side wall 12, before being threaded into the threaded hole in the joint portion 16, to retain the wall and joint portion to one another. The fastener 24 is preferably a light-duty or relatively small grade fastener, such as an M4 sized fastener. Exemplary embodiments may include a retainer 34 in the form of a latch 36 rather than a fastener 24, whereby the latch 36 has corresponding components on each of the wall 12 and covering portion 16. The latch 36 may be disposed on the wall 12 or on the covering portion 16 and be connectable to the other for retaining the wall to the covering portion and vice versa. For example, the latch 36 may be provided by way of a loop and clasp style latch. Advantageously, a retainer 34 of this type allows the partially removable front side wall 12 to be retained against, and released from, the joint portion 16 quickly and easily.

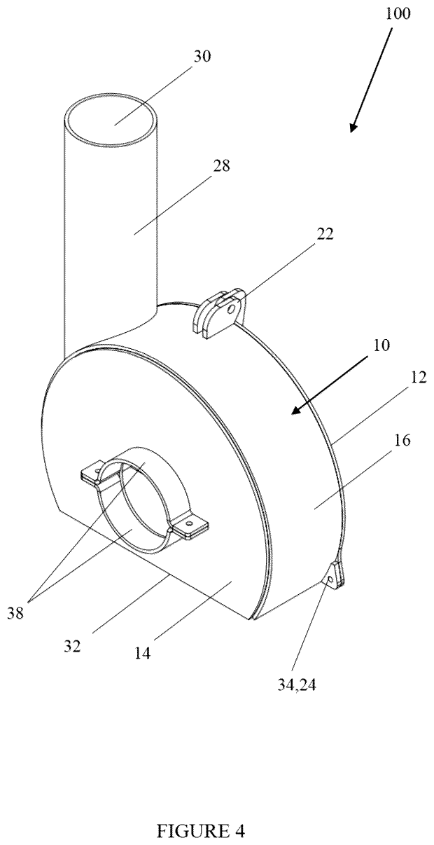

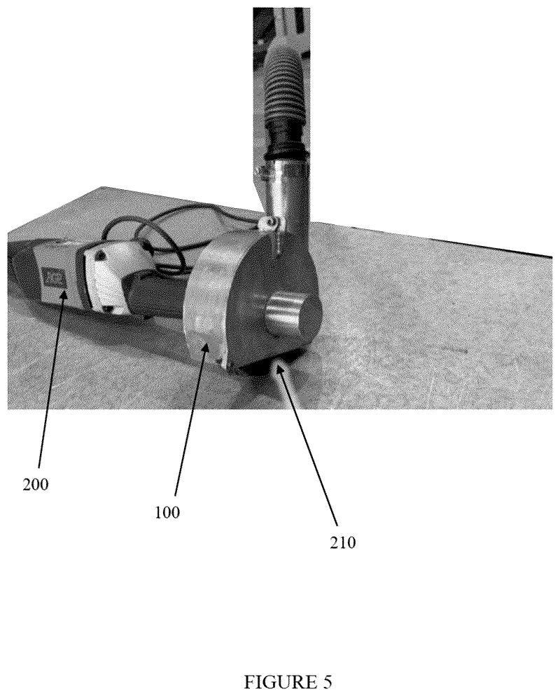

As shown in FIGS. 4 and 5, the second wall 14, being the wall that is not partially removable and which does not include the protrusion 20, includes a coupler 26 with which the extractor 100 can be attached to a/the grinder 200. The coupler 26 is in the form of a ring which, when fastened, decreases in diameter to secure the grinder thereto. In the embodiment shown, the ring is provided in two halves or coupling portions 38, with bolts extending between the two halves to decrease the diameter of the ring and thus secure the grinder. In this way, the coupling portions 38 are fastenable together to couple the grinder 200 therebetween. Alternatively, other decreasing diameter couplers 26 can be used, such as worm-style hose clamps and/or elastic loop fasteners. Where the coupler 26 is as shown in FIG. 4, the bolts extending between the halves of the coupler 26 can be secured using wing nuts, or other nuts fastenable without the use of a specialty tool, to assist in the rapid attachment and removal of the attachment 100. Any fasteners used with the coupler 26 can be captive fasteners to prevent loss and aid in coupling the extractor 100 to the grinder 200.

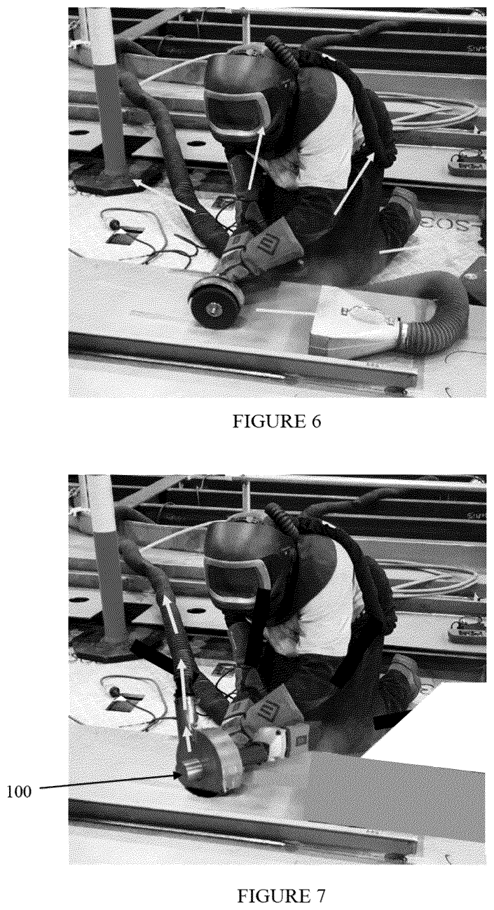

The extractor 100 comprises a port 28 for extracting particulate created by operation of the grinder 200 on a material. Best seen in FIG. 4, the port 28 extends, at one end, away from the centre of the extractor 100, preferably in a direction substantially opposite to the flattened portion 18/wall edges 32 (i.e., typically upwards in use). At the opposite end, the port 28 extends into the body 10 of the extractor 100, preferably into the covering portion 16 of the body 10 of the attachment 100. Importantly, the port 28 has (i.e., includes/provides) a passageway from in/inside the body 10 to an outlet 30 of the port 28. Accordingly, where the port 28 is extended into the body 10, the port 28 includes an aperture through the body 10 (and thus into the partial enclosure provided by the body 10). The port 28 is in the form of a tubular or cylindrical extension, preferably being substantially circular in cross-section. The port 28 provides a fitment point to which a vacuum source, such as, for example, a vacuum dust extractor, may be fitted. When in use, the vacuum source is powered to provide a suction force to the interior of the extractor 100 to draw particulate created by operation of the grinder 20 on a material (i.e., pull dust and other grinding debris) from inside the body 10, including around the disc 210, up through the port 28 to the outlet 30 thereof for extraction away from the user and work area. In exemplary embodiments, the passageway provided by the port 28 is positioned such that it extends from the covering portion 16 of the body 10 to the outlet 30 of the port 28. In this way, when operated, the port 28 is positioned to draw grinding particulate from an outer circumference of the grinding disc 210 when vacuum is applied to the port 28, rather than, for example, from a face of the grinding disc 210. This allows the extractor 100 to be particularly useful for extracting grinding particulate created during barrel grinding or similar grinding operation, wherein the edge of the grinding disc 210 is used instead of or primarily from the face of the grinding disc 210. FIG. 6 shows a prior art grinder, without the extractor 100 attached, in use. In the Figure, the yellow arrows indicate the direction of particulate created by operation of the grinder 200 being flung it various directions. In FIG. 7, the same grinding operation is shown but with an embodiment of the extractor 100 as disclosed herein attached to the grinder 200. The yellow arrows included in FIG. 7 highlight the extraction path followed by particulate created by operation of the grinder 200 when the extractor 100 is fitted. The particulate is drawn into the port 28, before being sucked into the vacuum ducting fitted to the outlet 30 of the port 28 for extraction. Almost all the particulate generated during grinding is captured by the extractor 100, and thus no yellow arrows are included as the particulate is not flung in various directions like in FIG. 6. To effect fitment of a vacuum source, the end of the port 28 spaced from the body 10 of the extractor 100 may include a fitting 40. The fitting 40, therefore, is disposes proximate the outlet 30 of the port 28, and provides for fitment of a vacuum source thereto. In exemplary embodiments, the fitting 40 is in the form of a bayonet fitting. The fitting 40 may additionally include O-rings are a similar scaling ring to prevent air and/or particulate from escaping from the extractor 100 prior to extraction. Alternatively, the fitting may include a simple hose clamp or similar clamp, or a threaded fitting. Advantageously, an effect of the described shape and positioning of the port 28, means that, in use, a user can additionally grip the port 28, to provide greater control over the grinder 200 and/or to prevent strain from holding the grinder 200 at its handle (typically being distanced from the disc 210 further than the positioning of the port 28).

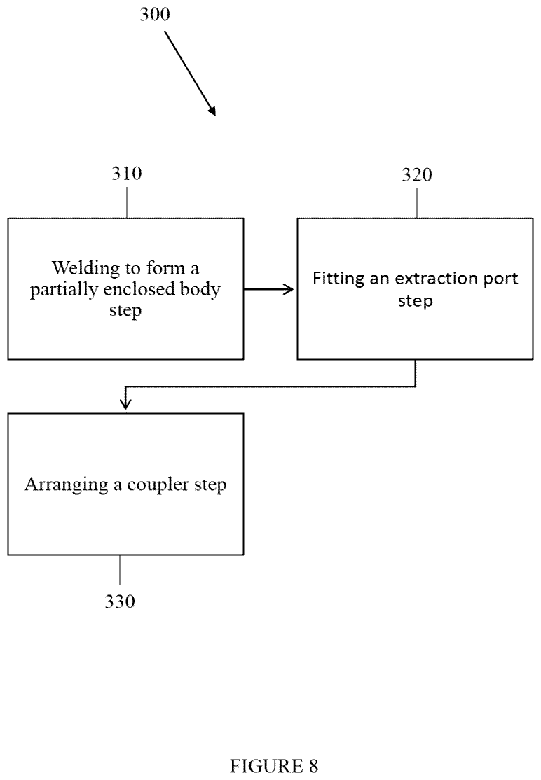

A method 300 of fabricating an extractor 100 for a grinder 200 will now be described with reference to FIG. 8.

In a first welding step 310, a covering portion 16 is welded around a perimeter of a pair of spaces apart walls 12, 14 to form a partially enclosed body. In this sense, the covering portion 16 extends only partially around the walls 12, 14 but is preferably completely welded, and/or otherwise sealed, to ensure that where the covering portion 16 and walls 12, 14 are welded, they provide an effectively (partially) enclosed body. In the method 300, welding the walls 12, 14 and covering portion 16 is preferably done in a way which results in a fabricated extractor 100 have wall 12, 14 which are substantially parallel to one another (and spaced), and in which the covering portion 16 is substantially perpendicular to (both of) the walls 12, 14. In a second ‘fitting’ step 320, a port 28 is fitted to the body 10 to provide a passageway from in/inside the body 10 to an outlet 30 of the port 28. Fitment of the port 28 preferably includes cutting a hole, corresponding to the size/shape of the port 28, in the covering portion 16 of the body, before welding or otherwise fixedly attaching the port 28 thereto. Finally, ‘arranging’ step 330 provides arranging a coupler 26 on one of the walls 12, 14 (preferably a first wall 12). The coupler 26 is for coupling the extractor 100, once fabricated, to a grinder 200 and for positioning the body 10 of the extractor 100 around (a grinding disc 210 of) the grinder 200.

In use, the extractor 100 is particularly useful in removing marine-or ship-paint primer paint from metal surfaces. It has been found, by the Applicant, that grinding operations which remove primer paint coatings from metal surface produce a large amount of particulates, and that, therefore, the use of an extractor 100 in accordance with the present invention is particularly suited to extract these particulates before they become airborne and pose health and safety risks in a marine/ship building work area. This is particularly the case for marine grade primer paints which release dangerous inorganic zinc particulate. Furthermore, the extractor 100 being able to be fabricated from steel allows the extractor 100 to be easily fabricated on-site at such marine/ship building locations, and is therefore readily available without the requirement to wait on external manufacturing from a separate supplier, for example.

The extractor 100 may provide several effects when used during the manufacture of marine vessels. Primarily, the extractor 100 serves to provide an effective combined grinder guard and dust extractor, substantially preventing particulate such as dust and other grinding debris from entering the environment (including through inhalation by a user) and substantially preventing injury from a user or other person touching or otherwise contacting the grinding disc 210 while operated. The inclusion of the walls 12, 14 and covering portion 18 form a partial enclosure or encasing body 10 about the disc 210 of the grinder. The extractor 100 is additionally removable from the grinder 200, meaning that a single extractor 100 can be shared between multiple grinders, and that an extractor 100 can be retrofitted to an existing grinder. Furthermore, including a wall 12 which is partially removable, by inclusion of a hinge 22 for hingedly opening the wall from the body 10, provides access to the inside of the body and to the grinder when the wall is partially removed or open. This results in an extractor 100 with which a user is able to remove and replace consumable grinding discs 210 attached to the grinder 200 that the extractor 100 is attached to, without having to remove the extractor 100 (entirely) from the grinder 200.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

The presence of “/” in a FIG. or text herein is understood to mean “and/or” unless otherwise indicated, i.e., “A/B” is understood to mean “A, or B, or both A and B”. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “substantially” can indicate a percentage greater than or equal to 80% or 90%, for instance, 92.5%, 95%, 97.5%, 99%, or 100%. The term “proximate” can mean “close to” or “on”, including directly in contact with, on, above or next to, depending on the context.

LIST OF REFERENCE SIGNS

| | |
|---|---|
| 10 | Body |
| 12 | Front side wall |
| 14 | Rear side wall |
| 16 | Covering portion |
| 18 | Flattened portion |
| 20 | Protrusion |
| 22 | Hinge |
| 24 | Fastener |
| 26 | Coupler |
| 28 | Port |
| 30 | Port outlet |
| 32 | Wall edges |
| 34 | Retainer |
| 36 | Latch |
| 38 | Coupling portions |
| 40 | Fitting |
| 100 | Extractor |
| 200 | Grinder |
| 210 | Grinding disc |
| 220 | Grinding disc fastener |
| 300 | Method |
| 310 | First step |
| 320 | Second step |
| 330 | Third step |

What is claimed is:

1. An extractor for a grinder, the extractor comprising:
a partially enclosed body for positioning around a grinding disc of the grinder, the body having first and second walls welded to a covering portion that extends partially around a perimeter of each wall; and
a port on the body with a passageway from the body to an outlet of the port, wherein vacuum applied to the port draws grinding particulate created by operation of the grinder on a material from inside the body to the outlet for extraction.

2. The extractor according to claim 1, wherein one of the walls is partially removable to provide access for removing the grinding disc without removal of the extractor.

3. The extractor according to claim 2, wherein the partially removable wall is hingedly attached to the covering portion.

4. The extractor according to claim 2, further comprising a retainer for retaining the partially removable wall to the covering portion.

5. The extractor according to claim 4, wherein the retainer comprises one of: a fastener fastenable through the partially removable wall and to the covering portion for retaining the partially removable door to the covering portion; or a latch disposed on the wall or on the covering portion and connectable to the other for retaining the wall to the covering portion.

6. The extractor according to claim 1, wherein the second wall comprises a coupler for coupling the extractor to the grinder and positioning the body around the grinding disc of the grinder.

7. The extractor according to claim 6, wherein the coupler comprises coupling portions fastenable together to couple the grinder therebetween.

8. The extractor according to claim 1, wherein the passageway of the port is from the covering portion of the body to the outlet of the port.

9. The extractor according to claim 1, wherein the port is positioned to draw grinding particulate from an outer circumference of the grinding disc when vacuum is applied thereto.

10. The extractor according to claim 1, wherein the extraction port comprises a fitting disposed proximate the outlet of the port, the fitting for fitment of a vacuum source thereto.

11. The extractor according to claim 10, wherein the fitting is in the form of a bayonet fitting.

12. The extractor according to claim 1, wherein the first and second walls comprise edges corresponding to a portion of each wall which the covering portion does not extend partially around, and past which the grinding disc of the grinder is exposed when a grinder is attached to the extractor.

13. The extractor according to claim 12, wherein the edges are substantially planar.

14. The extractor according to claim 1, wherein the first wall comprises a protrusion for housing a grinding disc fastener of the grinder when the extractor is attached to the grinder.

15. The extractor according to claim 1, wherein the walls are substantially circular and comprise a diameter of about 166 mm.

16. The extractor according to claim 1, wherein the walls and the covering portion are fabricated from steel or stainless steel.

17. The extractor according to claim 1, wherein the extractor is for attachment to a barrel grinder.

18. A barrel grinder having:
the extractor according to claim 1; and
a grinding disc or an abrasive disc.

19. A method of fabricating an extractor for a grinder, comprising:
welding a covering portion around a perimeter of a pair of spaced apart walls to form a partially enclosed body;
fitting, to the body, a port to provide a passageway from in the body to an outlet of the port; and
arranging a coupler, for coupling the extractor to a grinder and positioning the body around the grinder, on one of the walls.

20. The method according to claim 19, wherein the walls are substantially parallel to one another, and the covering portion is substantially perpendicular to the walls.
